(19) United States
(12) Patent Application Publication
(10) Pub. No.: US 2009/0313995 A1
(43) Pub. Date: Dec. 24, 2009

(54) POWER GENERATION SYSTEM

(75) Inventor: Edward Leszek Zakrzewski, Purley (GB)

Correspondence Address: WOLF GREENFIELD & SACKS, P.C., 600 ATLANTIC AVENUE, BOSTON, MA, 02210-2206, US

(73) Assignee: 2OC Ltd., Bristol (GB)

(21) Appl. No.: 12/486,218

(22) Filed: Jun. 17, 2009

(30) Foreign Application Priority Data
Jun. 20, 2008 (GB) 0811428.2

(51) Int. Cl. F03G 6/00

(52) U.S. Cl. 60/641.8

(57) ABSTRACT

A power generation system comprising: at least one solar collector arranged to heat deliver energy to a fluid so as to boil the fluid to form a vapour at least one prime mover arranged to receive the vapour and to be driven thereby so as to drive a load, and a condenser for returning the vapour to a liquid phase, and a compressor for compressing/pressurising the fluid, the power generation system further including a gas pressure reduction station for reducing the pressure of natural gas, and wherein the cold generated at the gas pressure reduction station is supplied to the condenser.

### FIELD OF THE INVENTION

The present invention relates to a concentrated solar power system in which a fluid is heated by solar power so as to vaporise it, and the vapour is used for a process, such as driving a turbine for power generation.

### BACKGROUND OF THE INVENTION

Concentrated solar power plants are known where a solar collection and focusing system concentrates solar power into a small volume through which a heat exchanger passes. The heat exchanger may simply be a pipe which is located within the region of high solar flux. A working fluid is boiled by the solar heating and then used to drive a turbine for generating electricity. Generally it is desirable not to lose the working fluid, so after the vapour has passed through the turbine it is routed to a condenser.

### SUMMARY OF THE INVENTION

According to the present invention there is provided a power generation system comprising:
at least one solar collector arranged to deliver energy to a fluid so as to boil the fluid to form a vapour; at least one prime mover arranged to receive the vapour and to be driven thereby so as to drive a load; a condenser for returning the vapour to a liquid phase; and a compressor to pressurise the fluid; the power generation system further including a gas pressure reduction station for reducing the pressure of natural gas, and wherein the cooling power generated at the gas pressure reduction station is supplied to the condenser.

It is thus possible to use a concentrated solar power generation system in regions where water for cooling purposes is in short supply, provided that a source of pressurised gas from gas fields is available. These conditions are often met in the oil and gas producing states of the Middle East.

However, whilst water is the most commonly used “working” fluid, water is not the only heat transfer medium that may be used. Organic Rankine engines and systems are known and these can be used with the solar collector.

Preferably the gas pressure reduction station also includes a turbine driven by the gas as it expands and an electrical generator driven by the turbine.

Consequently both the solar system and the gas pressure reduction system generate electricity. This combination has several advantages.
1) The size of the solar power generation system can be reduced.
2) The cooling requirements to condense the working fluid are reduced.
3) Electricity can be generated at night.
4) The power output of the combined plant peaks when the thermal energy density reaching the solar power system is at its greatest, which corresponds closely to when a peak in demand for air conditioning occurs.

### BRIEF DESCRIPTION OF THE ACCOMPANYING DRAWINGS

The present invention will be described, by way of example only, with reference to the accompanying Figures, in which:

FIG. 1 is a schematic diagram of a concentrated solar power generation system constituting an embodiment of the present invention; and

FIG. 2 is a schematic diagram showing the gas let down station in detail,

### DESCRIPTION OF PREFERRED EMBODIMENTS

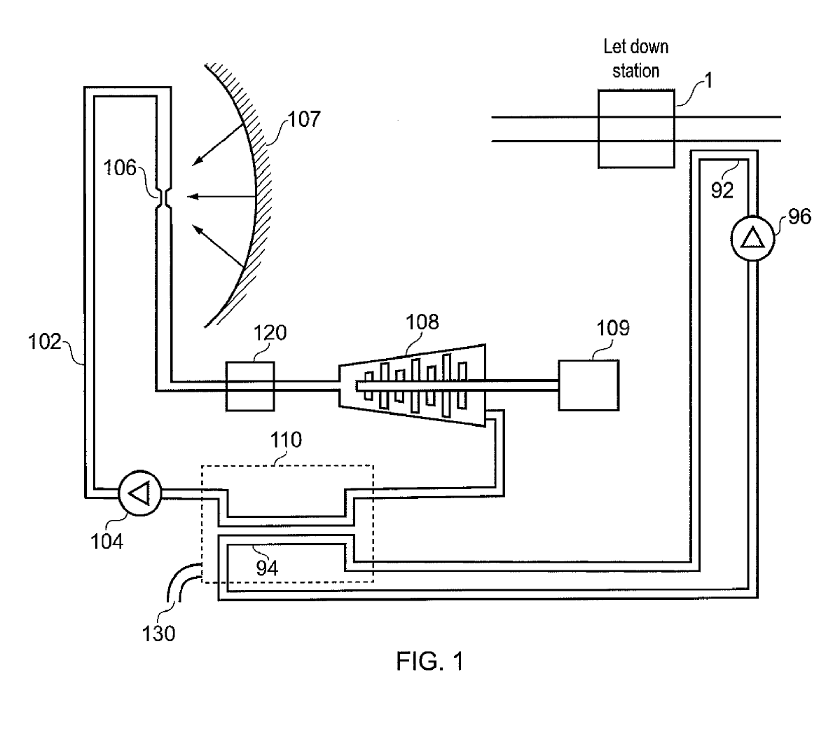

FIG. 1 schematically illustrates a concentrated solar power, steam generation and gas pressure let down system constituting an embodiment of the present invention.

A working fluid is held within a closed circuit 102. Fluid within the closed circuit circulates around the closed circuit. Starting at an outlet pump or compressor 104 the working fluid is in a liquid phase. The working fluid is pumped towards a heating region 106 where it is warmed by solar power, for example directed to a focal point by a mirror 107, so as to cause the fluid to undergo a phase transition to the vapour phase, and thereby to undergo a significant volumetric expansion. The vapour is then conveyed towards a Prime mover, such as turbine 108 where the vapour is allowed to expand. During the expansion its thermal energy is converted into mechanical work by the turbine. The turbine 108 drives a load, such as a generator 109.

Cooled vapour exits the turbine and is conveyed to a condenser 110 where it is cooled to a liquid phase. The liquid is then delivered to the pump and the cycle starts again.

The condenser requires some way of removing the heat from the vapour. Delivery of the heat into rivers or the sea is only possible if the plant is built next to a river with a sufficient and reliable flow and clearly delivery to the sea is only possible if the plant is built on the coast. Furthermore there are environmental concerns about the damage caused to marine ecosystems by such thermal discharge.

In variations on this theme, molten salts may be used in a sub-loop to collect heat form the heating region, and these may exchange heat with a further sub-loop having water in it, where this loop includes the compressor and the turbine 108.

In further variations a thermal store may be provided such that energy can be saved during the day for release later, so as to vaporise the working fluid if sunlight becomes unavailable.

The amount of thermal energy that needs to be dissipated can be significant.

Consider, for example, a solar driven power station having a design electrical output of 50 MW. The generation process typically has an efficiency of 40% or so (thermodynamic efficiency of a Camot cycle is (TH−TC)/TH where TH is the absolute temperature of the hot source and TC is the absolute temperature of the cold sink).

It can therefore be seen that at 40% efficiency the thermal input the system by the solar collector is around 120 MW.

This means that, in the steady state, 120−50=70 MW of heat needs to be dumped by the solar power and steam generation plant. This level of cooling for European power plants operating of Fossil fuel is usually achieved by large cooling towers and use of quantities of water that give rise to large plumes of vapour.

Solar power plants are built in locations where strong sunshine is prevalent. These places, by their very nature, have restricted supplies of water to use as a coolant.

In a different field of endeavour it is known that natural gas is generally under considerable pressure when extracted from the gas reservoir. This pressure is often maintained in a high pressure distribution system, although it may be let down to an intermediate pressure for distribution before being reduced to low pressure for delivery to users. Typically pressures of 70 atmospheres, 30 atmospheres and a few atmospheres excess (above atmospheric) pressure are used.

At each transition between distribution systems where the pressure needs to be reduced, the gas passes through a pressure reduction station, generally designated 1.

Each gas pressure reduction station 1 includes reduction means, such as Joule Thompson valves or a turbo-expander. As the gas reduces in pressure it performs mechanical work. The expansion process is substantially adiabatic and hence the gas temperature drops. The temperature reduction can be so great that earth in the vicinity of the outlet pipe from the gas pressure reduction station may freeze. This can give rise to ground heave and hence heat is added to the gas to stop the freezing from occurring. This pressure reduction can be regarded as a source of “cooling power” or “cold” that can be used in other processes,

Heat can be provided to the reduction station to prevent the freezing. The heat can be supplied by burning the gas itself; or by an external fluid source, such as diesel or bio-diesel which may be used to run an engine-generator set with heat from the engine being used to warm the gas.

Such a system is described in EP 1865249 the teachings of which are incorporated herein by reference.

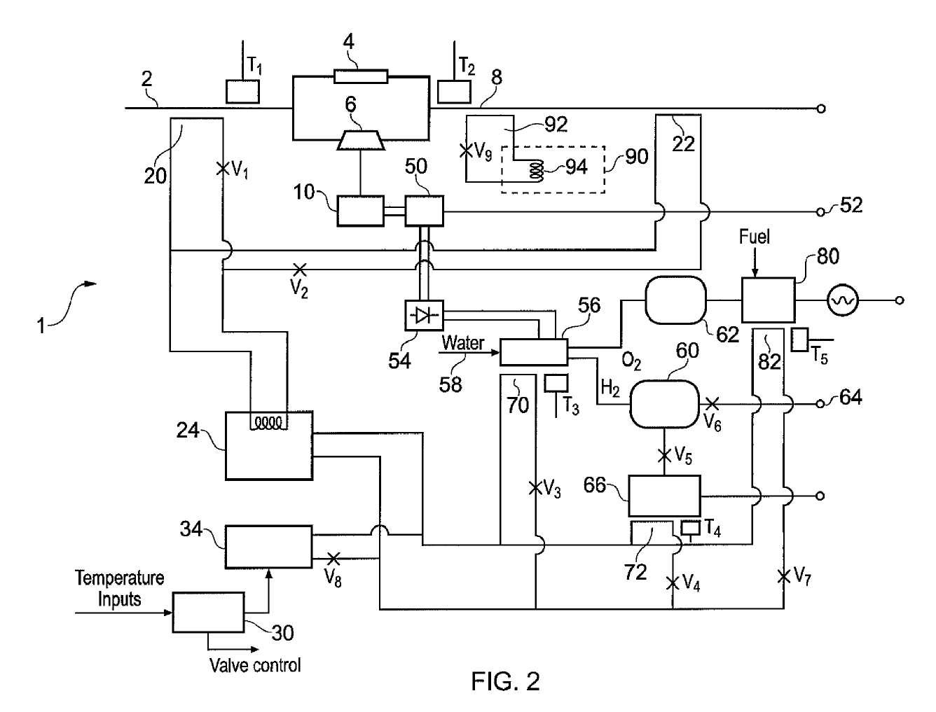

FIG. 2 schematically illustrates a gas pressure reducer 1 as described in EP 1865249. Gas at a first pressure is provided along a first gas main, generally designated 2, towards one or more gas expanders 4 and 6. Gas passing through either or both of the gas expanders 4 and 6 undergoes a pressure reduction and reduced pressure gas is output along a second gas pipe designated 8. In this example the gas expander 4 is a valve based gas expander, such as a Joule-Thomson valve, whereas the gas expander 6 is a turbo expander which is adapted to drive an electricity generator 10.

In use, the Joule Thompson valve 4 or the turbo expander 6 can be controlled in a known manner to vary the gas flow or pressure through the pressure reducer in accordance with the demand on the gas distribution system at that time.

A heat exchanger 20 is provided in thermal contact with the gas in the supply pipe 2 so as to warm the gas prior to its entry to the gas expanders 4 and 6. Similarly a further heat exchanger 22 may be provided in thermal contact with the gas downstream of the expanders 4 and 6 so as to perform further heating of the gas if necessary. The heat exchangers 20 and 22 receive a warmed fluid from a central heat exchanger 24 which includes a pump (not shown) in order to ensure that a sufficient amount of fluid circulation occurs within each of the heat exchange paths. The fluid may be gas. Electrically or electro-pneumatically operated control valves V1 and V2 are operable under the control of a controller 30 so as to set the flow rates through the heat exchangers 20 and 22. The controller 30 also controls the rate of fuel utilisation by a diesel, a bio-diesel unit or a bio-fuel burner 34 which generates heat which is provided along an input path to the heat exchanger 24. Thus the fluid flow paths on the input side to the exchanger 24 and on the output side of the exchanger 24 never intermingle. Other heat exchanger topologies are permissible which may mix the flow paths. Fluid flow from the burner 34 can be regulated by control valve V8. Additional backup heat exchangers corresponding to exchangers 20 and 22 and backup bio-fuel engines or burners corresponding to engine 34 can be provided in order to ensure redundancy at the gas expansion station.

In order to facilitate regulation of the gas temperature one or more gas temperature sensors designated T1 and T2 may provide inputs to the controller 30 such that it can control the amount of heat generated by the heater or engine 34 in order to match that required to maintain the target temperature at the output of the gas expander, and as measured by temperature sensor T2. Sensor T1 may be omitted if it is placed upstream of the heat exchanger 20, but is usefully included if it is placed downstream in order to provide an indication that the heat exchanger 20 and hence valve VI and heat exchanger 24 and the associated pump therein, is working correctly. Sensor T2 defines a temperature regulation location at which the control system strives to achieve a target temperature. The controller 30 may be an adaptive controller which includes a learning engine (such as a neural network) which learns the pattern of gas flow that occurs over a daily or weekly cycle. Additionally or alternatively the controller may receive data representing gas flow rates or expected gas flow rates such that the controller can set the pressure reduction station to a state suitable for a forthcoming gas flow rate—thereby stopping, for example, the temperature from falling below a target temperature when a predictable increase in gas flow occurs.

Advantageously the turbo expander 6 is used as the primary pressure reducing device. It can therefore drive a generator 10 whose output may be passed through a switching unit and/or power controller 50. The power controller can supply electricity directly to an electrical output 52 which may supply local devices or alternatively which may represent a connection to the national grid. Additionally the switching unit and power controller 50 may supply electricity to a rectifier 54 which in turn provides a DC supply to an electrolysis unit 56. The electrolysis unit receives a regulated supply of water from a water supply 58 and in turn generates hydrogen and oxygen which are supplied to a hydrogen store 60 and an oxygen store 62, respectively. The hydrogen may be stored in the store 60 for subsequent delivery via a valve V6 to a hydrogen fuel output 64, hydrogen may be used as a fuel for example, for motor vehicles as the waste product of its combustion is merely water and hence it is non-polluting at the point of use. Hydrogen in the store 60 may also be directed by way of a control valve V5 towards a fuel cell 66 which can be used to generate electricity.

The electrolysis unit 56 and the fuel cell 66 each generate heat whilst in use and their temperatures are measured by temperature sensors T3 and T4, respectively, which act as inputs to the controller 30. Each of the electrolysis units and the fuel cell is in thermal contact with a heat exchanger 70 and 72, respectively, which can extract heat from the electrolysis unit 56 and the fuel cell 66 and supply that heat to the central heat exchanger 24. In order to control the rate of extraction, electrically controllable valves V3 and V4 operable under control of the controller 30 are provided in order to ensure that the temperature of the electrolysis unit 36 and the temperature of the fuel cell 66 are maintained within acceptable ranges, that is not too hot and not too cold. Oxygen in the oxygen store 62 may be provided to a further burner 80 which may burn any suitable fuel, but advantageously bio-fuel, in order to generate heat which in turn may be collected by a further heat exchanger 82 and provided to the central heat exchanger 24 by way of controllable valve V7 in order to provide heat for heating the gas in the vicinity of the expansion devices 4 and 6. Additionally or alternatively heat from the burner 80 may be used for heating the buildings and/or generation of steam as part of an industrial manufacturing process or for the generation of electricity. The burner may include the facility to use hydrogen peroxide as a “flameless” fuel in the production of heat, which is collected by heat exchanger 82.

Electrolysis units, such as 56, typically comprise an anode and a cathode separated by a physical barrier, such as a porous diaphragm of asbestos, or a micro-porous separator of PTFE or the like. Alternatively an aquious electrolyte containing a small amount of an ionically conducting acid or base may be used. Electrolysis units are commercially available and need not be described further. Similarly fuel cells are commercially available for example from FUEL CELL ENERGY of the USA and hence also need not be described in detail.

As a further refinement to the invention, hygroscopic antifreeze may be injected into the supply main 2 via an injection unit (not shown) and subsequently recovered following the gas expansion.

The controller 30 advantageously controls each of the valves V1 to V8.

It is permissible to allow the gas exiting the expansion devices, i.e. value 4 or turbo expander 6, to drop below 0° C. This can be advantageous where cooling power is required by another process.

The inventors have realised that, during the daytime, the heat required to warm the gas can be recovered from the condenser of a concentrated solar power system as shown in FIG. 1. During the night time the concentrated solar power system is not functional so the heat sources described in FIG. 2 are still required to warm the gas. This can be achieved by a heat exchanger 92 down steam of the expansion valve such that “cold” can be extracted from the gas and delivered to a further heat exchanger 94 of the condenser. A pump 96 is provided to ensure circulation of a heat exchange fluid.

However, if one goes back to consider how much cooling power is required by a solar electricity generation system then it can be seen that a considerable reduction in environmental impact can be achieved.

However, the benefits are significantly greater than might have been expected because for a given nominal power output the size of the solar plant can be reduced because its electrical generation can be augmented by the generator of the gas let down station.

Suppose, we return to the example of the 50 MW solar plant. It only generates for a few hours of a day. If the solar portion was reduced to 25 MW and teamed with a 25 MW generator working from a gas pressure letdown (pressure reduction) station then we still get a peak generation of 50 MW.

However, unlike the totally solar station, we still have a generator capacity of 25 MW at night when the solar portion in inoperable. Additionally to achieve the 50 MW output only 38 MW of heat needs to be dumped from the solar portion of the combined solar and gas pressure reduction generation plant. However a significant proportion of this excess heat can be used to warm the gas out of the pressure let down station. An additional 50-70 MW of thermal energy can be sunk into the gas stream. 50 MW without raising the outlet temperature above inlet and up to 70 MW by raising the outlet temperature by around 10 Centigrade above the inlet temperature.

Thus the combination of the technologies addresses the needs of each other, but also gives rise to an advantageous synergy.

The controller 30 can be arranged to deliver cooled fluid to the condenser so as to extract heat therefrom and to operate the heat sources, such as the bio-diesel fuelled engine 34, fuel cell 66 and supplementary burners or additional engines such that the heat generated by these sources exceeds the heat load required to warm the gas entering the gas pressure reducer to a target value or, alternatively, to control the temperature of the gas leaving to a target value.

In some embodiments where an electrolysis plant is provided, the oxygen produced as part of the electrolysis process may be returned to the engine or burner in order to modify its operation. In particular, oxygen may be used to enrich the air supply to the internal combustion engine (or may be used in a post engine secondary burner process) to reduce or modify the pollutants within the exhaust gas or increase the efficiency of the engine.

Multiple engines may be provided such that the heat output from the engines may be controlled by selecting the number of engines that are operating at a given time. The engine or engines can be used to drive generators. These can be used to supply electricity to consumers or businesses. Similarly the CO₂ enriched exhaust from the engines may be ducted to greenhouses or the like where the CO₂ enhances the growth of plants.

By utilising a heater or engine for generating heat which has a fuel which has not derived from the gas supply itself, issues concerning safety or reliability of extracting high pressure gas are avoided and similarly a heating capability is provided so as to warm the components of the gas reduction station prior to resumption of a gas supply if the gas supply had to be interrupted. This avoids the formation of ice or deposits within the pipe during transitory phases such as start up.

The use of the gas pressure let down station in combination with the concentrated solar power system alleviates the cooling requirements on the solar system and makes it feasible to install the system in places where solar power is abundant but water is in short supply.

The use of the gas pressure let down station is advantageous compared to cooling towers, as it avoids the large capital costs of building the towers. Also, cooling towers consume a lot of water, and consume power to pump the water within the tower. The let down station also has advantages over “Fin-fan” cooling systems, as these systems typically use about 5% of the power generated to run the cooling system, and possibly more in desert environments. Thus, the let-down station approach is much less consuming of electricity, and can be a net generator when a turbine is used to drive a generator.

The solar power plant may be modified to work with sea water or other non-drinkable water so as to produce drinking water via evaporation and condensation of the water and to deliver this to an outlet 130. A further heat source 120 may be provided to augment or replace the solar heating if it is required to run the plant at night. The further heat source 120 may be a fossil fuel or bio fuelled burner or an engine. Heat from the engine can be used to augment or replace the solar heating whereas mechanical work from the engine may drive devices such as pumps or generators.

In the event that the let down and cooling station cannot use the entirety of the heat from the solar power plant, some of the heat can be used to provide cooling by way of an absorption chiller.

Absorption chillers are known to the person skilled in the art. However for completeness the following brief explanation is provided. The cooling cycle of an absorption chiller is similar to an engine driven chiller in that both systems use a low temperature liquid refrigerant that absorbs heat and in doing so it converts into a vapour phase. The refrigerant vapours are then compressed, converted into a liquid (which expels heat to the environment), and then expanded to a low pressure mixture of liquid and vapour which can then be reused. The absorption chiller uses heat to compress the refrigerant to high pressure.

In general the absorption cycle uses two fluids, the refrigerant and the absorbent. Water is commonly uses as the refrigerant and lithium bromide as the absorbent. During a refrigeration cycle the low pressure refrigerant vapour is absorbed into the absorbent releasing heat. The liquid refrigerant/absorbent solution is then pumped to high pressure. Heat is added, such as by steam or superheated brine, to cause the refrigerant to desorb from the absorbent and to vaporise. The vapour travels to a condenser where heat is rejected and the refrigerant condenses. The water is then throttled through an expansion valve where its pressure is reduced, and it evaporates thereby absorbing heat and providing cooling.

Thus high grade excess heat can be used to provide chilling of air or water.

The chiller may be remote from the solar plant and could easily be several miles away.

1. A power generation system comprising:
at least one solar collector arranged to deliver energy to a fluid so as to boil the fluid to form a vapour;
at least one prime mover arranged to receive the vapour and to be driven thereby so as to drive a load;
a condenser for returning the vapour to a liquid phase; and
a compressor to pressurise fluid;
the power generation system further including a gas pressure reduction station for reducing the pressure of natural gas, and wherein the cooling power generated at the gas pressure reduction station is supplied to the condenser.

2. A power generation system as claimed in claim 1, in which the fluid is water.

3. A power generation system as claimed in claim 2, in which the water is sea water and at least some of the condensed vapour is output as desalinated water.

4. A power generation system as claimed in claim 1, in which the gas pressure reduction station comprises at least one of a turbine and a Joule Thompson valve.

5. A power generation system as claimed in claim 1, in which the gas pressure reduction station includes auxiliary heat producing devices.

6. A power generation system as claimed in claim 1, further including a secondary heat source to boil the fluid to form a vapour.

7. A power generator system as claimed in claim 4, in which the turbine drives a generator for the production of electricity.

8. A power generation system as claimed in claim 1 where the electrical energy output from a generator driven by the prime mover is substantially equivalent to the electrical energy output from a generator driven by a turbine in the gas pressure reduction station.

9. A gas pressure let down station, comprising a heat exchanger for receiving fluid that has been warmed via solar power, whereby the heat exchanger is arranged to deliver heat to gas undergoing a pressure reduction step at the gas pressure let down station.

10. A gas pressure let down station as claimed in claim 9, further comprising heat sources for burning fuel to heat the gas.
